(19) United States
(12) Patent Application Publication
(10) Pub. No.: US 2002/0078229 A1
(43) Pub. Date: Jun. 20, 2002

(54) Method and router for setting up a connection via an IP-oriented network

(76) Inventors: Werner Lindemann, Mulheim (DE); Norbert Schonfeld, Dortmund (DE)

Correspondence Address: BELL, BOYD & LLOYD, LLC, P. O. BOX 1135, CHICAGO, IL, 60690-1135, US

(21) Appl. No.: 09/682,901

(22) Filed: Oct. 31, 2001

(30) Foreign Application Priority Data
Oct. 31, 2000 (DE) 100 53 951.3

(51) Int. Cl. G06F 15/16; G06F 15/173

(52) U.S. Cl. 709/238; 709/230

(57) ABSTRACT

A method for setting up a communications connection via an IP-oriented network originating from a device connected to a local computer network, the local computer network being connected via a router device to a communications network, which in turn is connected via a multiplicity n of conversion devices to the IP-oriented network. A selection unit is implemented in the router device which, using information transferred by the device, selects one of the conversion devices. A connection is subsequently set up by the router device via the communications network to the selected conversion device.

### BACKGROUND OF THE INVENTION

The use of telecommunications services to transfer voice and data is increasing constantly due to the increasing globalization of companies. As a result, the costs incurred through these telecommunications services are rising constantly and are becoming a substantial cost factor for companies which are looking for ways to reduce these costs.

One way of transferring data at low cost and worldwide is offered by global computer networks; for example, the “Internet.” It is known, for example, from the article by Michael Wagner entitled “Szenarien der Internet-Telefonie” [“Internet Telephony Scenarios”], NTZ, Issue 5, 1998, pp. 48-49, for a transfer of voice data between two communications users to be implemented via the Internet. A connection is set up via the Internet by special devices which implement access to the Internet, frequently referred to in the literature as “Interworking Units” or “Internet Service Providers.”

In addition to global computer networks such as the Internet, companies frequently have in-house computer networks, referred to as LANs (Local Area Networks) which are connected via a router device to a conventional communications network; e.g., an ISDN-oriented network. Two-way conversion between the transmission protocol of the local computer network and the transmission protocol of the communications network is carried out by the router device. In addition, the router device is configured in such a way that, on initialization of an Internet connection originating from a LAN device connected to the local computer network, a communications connection, e.g., an ISDN connection, is set up automatically via the communications network to an Internet Service Provider pre-configured in the router device.

A disadvantage of this method is that, unlike a manual dial-in to the Internet, the Internet Service Provider cannot be selected by a user initializing the connection set-up on an individual connection basis, frequently referred to in the literature as “call by call.” Due to the pre-configuration of the router device, it is not possible to take account of particular temporary connection-specific conditions. Connection-specific conditions of this type are, for example:

instantaneous overload of the pre-configured Internet Service Provider;

the costs incurred in a connection set-up via a specific Internet Service Provider;

a specific quality requirement for the current connection—frequently referred to in the literature as “Quality of Service”;

a specific security requirement for the current connection;

an avoidance of special services linking an Internet Service Provider to a connection set-up, e.g., an avoidance of advertising messages for a connection set up via this Internet Service Provider; or

the use of special services with an Internet Service Provider.

In cases where an Internet Service Provider is to be selected on a call-by-call basis in a connection set-up originating from a LAN device connected to the local computer network, a CAPI interface (Common Application Programming Interface) implemented in the devices concerned is currently required. If no stand-alone hardware is available for each LAN device, a “client-server architecture” is also required, wherein the local CAPI interfaces implemented in the LAN devices are referred to as “CAPI Clients” and a central CAPI interface implemented in the router device is referred to as the “CAPI Server.” However, due to this client-server architecture, router-specific advantages, for example, common use of an ISDN connection to an Internet Service Provider by a number of LAN devices or the setting up of a common “firewall,” can no longer be used. In addition, implementation of the CAPI protocol in the local computer network produces a “protocol overhead,” i.e., an unfavorable relationship between the user information and control information which is to be transferred, since the user data to be transferred must be packed into the CAPI protocol in addition to a transmission protocol supported in the local computer network.

An object of the present invention is, therefore, to provide a method and a router device by which a connection-individual selection of an Internet Service Provider is enabled.

### SUMMARY OF THE INVENTION

According to the present invention, such object is achieved via a selection unit implemented in the router device. Via the router device, with reference to information transferred by a LAN device, one of the available conversion devices, i.e., one of the available Internet Service Providers, is selected and a communications connection is subsequently set up via the communications network to the selected Internet Service Provider.

One essential advantage of the method and router device selection unit according to the present invention is that the latter can be integrated into existing systems without substantial implementation outlay.

A further advantage of the selection unit according to the present invention is that, via a corresponding configuration of the selection unit, set-up of an Internet connection originating from an application running on a LAN device connected to the local computer network can be implemented without using a CAPI interface, so that the aforementioned disadvantages associated with a CAPI-oriented client-server architecture do not arise in the method according to the present invention.

According to a further embodiment of the present invention, the selection unit is designed as a server, whereby the information for setting up an Internet connection, i.e., a connection to a device disposed in the IP-oriented network such as a server or a personal computer, is transferred via a special Internet Service Provider via a separate socket connection between the corresponding LAN device and the router device. A separate application running on any given device is provided for this purpose. One advantage of this embodiment is, inter alia, that this further development represents a relatively simply programmable software solution.

According to another embodiment of the present invention, the selection unit is implemented in a similar manner to a DNS proxy unit (Domain Name Service). Thereby, on the one hand, a high degree of flexibility is achieved in a simple manner and, on the other hand, by providing only one application for the initialization of an Internet connection and the transfer of the information identifying an Internet Service Provider, a high degree of user-friendliness is achieved.

Another embodiment of the present invention concerns the design of the selection unit as an IP address filter, which can be implemented in a simpler manner compared with the design of the selection unit similar to a DNS proxy unit.

Additional features and advantages of the present invention are described in, and will be apparent from, the following Detailed Description of the Invention and the Figures.

### BRIEF DESCRIPTION OF THE FIGURES

FIG. 1 shows a structural diagram for schematic representation of the essential functional units involved in the method according to the present invention.

FIG. 2 shows a structural diagram for schematic representation of a first exemplary embodiment of the present invention.

FIG. 3 shows a structural diagram for schematic representation of a second exemplary embodiment of the present invention.

FIG. 4 shows a structural diagram for schematic representation of a third exemplary embodiment of the present invention.

### DETAILED DESCRIPTION OF THE INVENTION

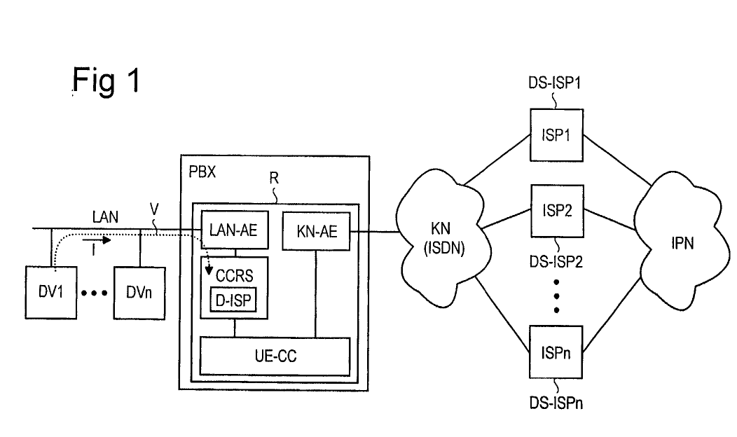

FIG. 1 shows a schematic representation of a communications system PBX with a router device R disposed in the communications system PBX. The router device R is connected via a LAN connection unit LAN-AE to a local computer network LAN (Local Area Network) and via a communications network connection unit KN-AE to a communications network KN; for example, an ISDN-oriented communications network (shown by the “ISDN” in brackets). Two-way conversion between the transmission protocol of the local computer network LAN and the transmission protocol of the communications network KN is carried out by a conversion and control unit UE-CC disposed in the router device R. Alternatively, the router device R can be implemented as a stand-alone device; i.e., not implemented in a communications system PBX.

Data processing devices DV1, . . . , DVn, for example personal computers or workstations, are connected via the local computer network LAN to the communications system PBX. The communications network KN is connected via a number of conversion devices ISP1, . . . , ISPn, frequently referred to in the literature as Internet Service Providers, to a global IP-oriented network IPN, for example the Internet. In order to address the conversion devices ISP1, . . . , ISPn, a data record DS-ISP1, . . . , DS-ISPn, which uniquely identifies the relevant conversion device ISP1, . . . , ISPn, is allocated to each conversion device ISP1,. . . , ISPn. A data record DS-ISP1 , . . . , DS-ISPn includes, for example, a telephone number allocated to the relevant conversion device ISP1, . . . , ISPn in the communications network KN, an IP address allocated to the conversion device ISP1, . . . , ISPn in the IP-oriented network IPN, a user password, a user name, etc.

According to the present invention, a selection unit CCRS (CCRS: Call by Call Routing Support) connected to the LAN connection unit LAN-AE and to the conversion and control unit UE-CC is disposed in the router device R. Information D-ISP identifying a “default conversion device” is stored in the selection unit CCRS, wherein the router device R currently sets up a connection to the IP-oriented network IPN via the default conversion device. Using information I transmitted to the router device R by a data processing device DV1, . . . , DVn (in the present exemplary embodiment, the first data processing device DV1) connected to the local area network LAN, one of the available conversion devices ISP1, . . . , ISPn can be selected and set up as the new default conversion device, so that a connection is subsequently set up to the IP-oriented network IPN and via the newly selected conversion device ISP1, . . . , ISPn.

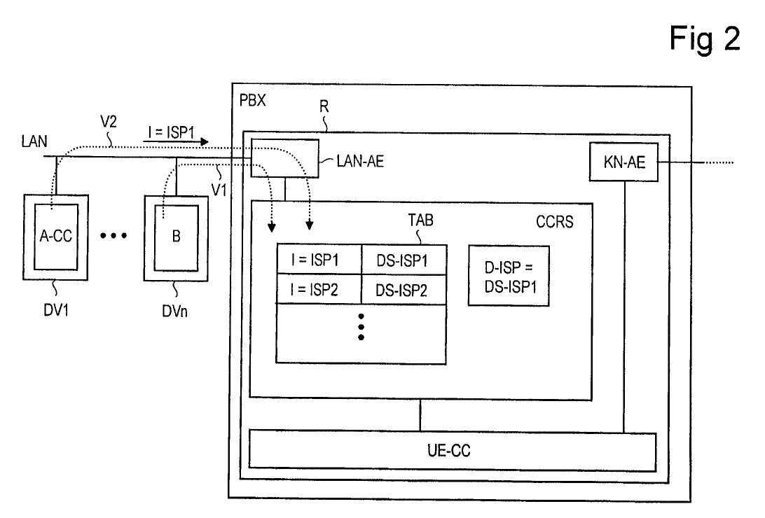

FIG. 2 shows a structural diagram for schematic representation of a first exemplary embodiment of the present invention, in which transfer of the information I is initiated by a separate application running on a data processing device DV1, . . . , DVn and the information is transferred via a separate IP connection.

According to the first exemplary embodiment, a first application B, for example a “Web browser,” is running on the nth data processing device DVn and a second application A-CC is running on the first data processing device DV1. Alternatively, the second application A-CC can be running on the nth data processing device DVn, or can be implemented as a stand-alone device connected to the local area network LAN, the communications network KN or the IP-oriented network IPN.

Via the second application A-CC, a separate IP connection V2 is set up between the second application A-CC and the selection unit CCRS via the local area network LAN. Information I for selecting a conversion device ISP1, . . . , ISPn is transferred via the separate connection V2 to the selection unit CCRS. This information I can be entered by a user, for example via an input form displayed by the second application A-CC on a display device of the first data processing device DV1, or via a displayed selection menu. In the present exemplary embodiment, a user has entered information I=“ISP1,” which is transferred via the separate connection V2 to the selection unit CCRS. The information may be an actually assigned name of a conversion device ISP1, . . . , ISPn, but may also be a corresponding “pseudonym” configured in the router device R, for which a corresponding data record DS of a conversion device ISP1, . . . , ISPn is stored in the selection unit CCRS.

With reference to a table TAB stored in the selection unit CCRS, a conversion device ISP1, . . . , ISPn is selected using the information I=“ISP1” transmitted by the first data processing device DV1. Information I identifying the relevant conversion devices ISP1, . . . , ISPn and, assigned to the information I, the data records DS-ISP1, . . . , DS-ISPn allocated to the relevant conversion devices ISP1, . . . , ISPn are stored in this table TAB for this purpose. In the present exemplary embodiment, the data record DS-ISP1 is allocated to the information I=“ISP1.” The first conversion device ISP1 is uniquely identified by the data record DS-ISP1, so that the information identifying a default conversion device is set to D-ISP=DS-ISP1.

In cases where no information I is transferred from the second application A-CC to the selection unit CCRS, it can be provided that the selection unit CCRS independently transmits a request message to the second application A-CC, via which information I is requested for the selection of a conversion device ISP1, . . . , ISPn as a default conversion device ISP1. Alternatively, the selection unit CCRS can be configured in such a way that the default conversion device, analogous to a “least-cost routing device,” is automatically reconfigured as a function of on the time of day.

An Internet connection, i.e., a communications connection to a device disposed in an IP-oriented network IPN, is initialized via the first application B; for example, when starting the application. A connection V1 is set up by the first application B between the first application B and the selection unit CCRS of the router device R via the local area network LAN for this purpose. A communications link is then set up via the communications network KN to the first conversion device ISP1 by the conversion and control unit UE-CC of the router device R using information D-ISP=DS-ISP1 which identifies the default conversion device. The Internet connection initialized by the nth data processing device DVn is set up via the first conversion device ISP1.

According to a first alternative of the first exemplary embodiment, all accesses of the first data processing device DV1 to devices disposed in the IP-oriented network IPN are routed from this time on via the first conversion device ISP1. If an older (no longer required) connection between the first data processing device DV1 and the IP-oriented network IPN already exists, this is automatically cleared down at the end of a configurable time period; frequently referred to in the literature as a “short-hold mechanism.” However, the older connection is not cleared down if this connection is still being used by a further device connected to the local area network LAN; i.e., the default conversion device can be defined for an individual device.

According to a second alternative of the first exemplary embodiment, each access by the data processing devices DV1, . . . , DVn connected to the local area network LAN to devices disposed in the IP-oriented network IPN is routed from this time on via the first conversion device ISP1; i.e., the default conversion device is defined on a network-wide basis.

A disadvantage of the first exemplary embodiment is that, in addition to the first application B, a separate second application A-CC is required, whereby the user-friendliness of this design of the present invention is rather low.

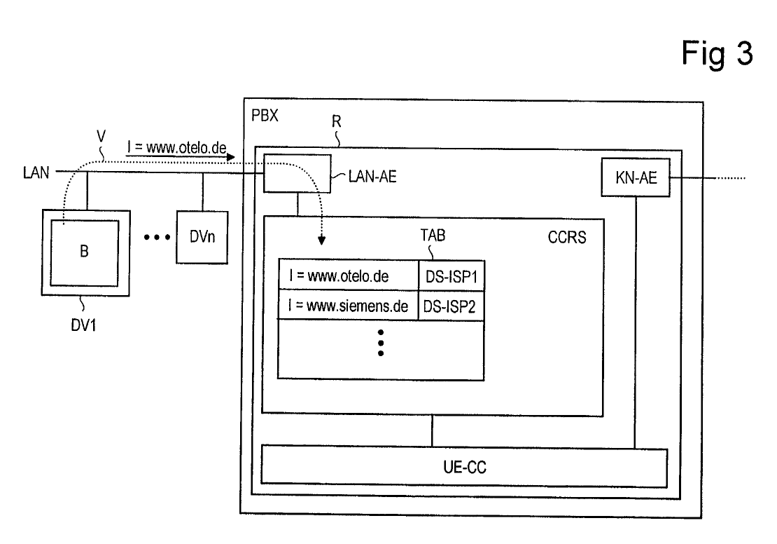

FIG. 3 shows a structural diagram for schematic representation of a second exemplary embodiment of the present invention in which the selection unit CCRS is designed similar to a “DNS proxy” (Domain Name Service). The Domain Name Service, referred to as DNS for short, provides Internet names, for example “www.siemens.de”, which a user can take in and remember more easily than a conventional IP address having a combination of digits; for example, 199.199.199.7. The DNS protocol is used here for one-way conversion of an Internet name into an IP address.

The table TAB which is stored in the selection unit CCRS of the router device R and is designed according to the second exemplary embodiment therefore contains, instead of the name information according to the first exemplary embodiment, Internet names allocated to the individual conversion devices ISP1, . . . , ISPn. Thus, an Internet name “www.otelo.de” is allocated to the first conversion device ISP1 and an Internet name “www.siemens.de” is allocated to the second conversion device ISP2. The data records DS-ISP1, DS-ISP2, . . . identifying the corresponding conversion devices ISP1, . . . , ISPn are, in each case, allocated to the information I (in the form of Internet names) and stored.

Analogous to the first exemplary embodiment, an Internet connection, i.e., a communications connection to a device disposed in the IP-oriented network IPN, is initialized by an application B; for example, a “Web browser” running on the first data processing device DV1. This is normally done when the application B is started. Information I in the form of an Internet name is transferred here by the application B to the selection unit CCRS during the connection; frequently referred to in the literature in this context as a “DNS enquiry.” In the present exemplary embodiment, information I=“www.otelo.de” is transferred by the application B to the selection unit CCRS.

As in the present exemplary embodiment, the information I can be any given name of a “homepage” of an Internet Service Provider, e.g., “www.otelo.de,” or may also be a pseudonym correspondingly configured in the router device R; e.g., “ISP1.” In the case of pseudonyms, an own internal IP address can be delivered back. This address is used below to illustrate corresponding acknowledgement messages.

With reference to the table TAB stored in the selection unit CCRS, a conversion device ISP1, . . . , ISPn is selected using the information I=“www.otelo.de” transferred by the first data processing device DV1. In the present exemplary embodiment, the data record DS-ISP1 is allocated to the information I=“www.otelo.de.” The first conversion device ISP1 is uniquely identified by the data record DS-ISP1, so that the DNS enquiry is forwarded by the conversion and control unit UE-CC of the router device R via the communications network to the first conversion device ISP1. The DNS enquiry is then answered by the first conversion device ISP1 in a corresponding manner.

An advantage of the second exemplary embodiment lies in its greater flexibility and greater user-friendliness compared with the first exemplary embodiment.

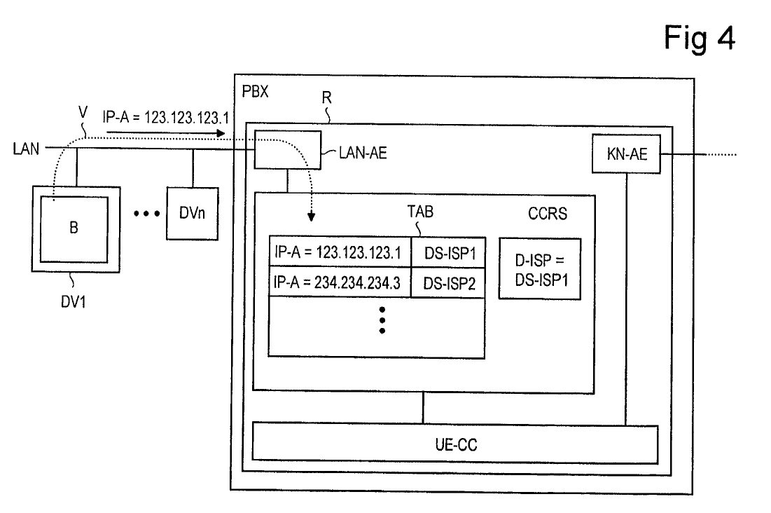

FIG. 4 shows a structural diagram for schematic representation of a third exemplary embodiment of the present invention, in which the selection unit CCRS is designed as an “IP address filter.” The table TAB stored in the selection unit CCRS of the router device R and designed according to the third exemplary embodiment contains a list of IP addresses IP-A and, assigned to the IP addresses IP-A, data records DS-ISP1, . . . , DS-ISPn identifying the relevant conversion devices ISP1, . . . , ISPn. When an IP address IP-A stored in the table TAB is received, the default conversion device is redefined; i.e., the data record DS identified by the IP address IP-A is re-allocated to the information D-ISP identifying the default conversion device.

Alternatively, it can also be provided that a communications connection set-up between the router device R and a new conversion device ISP1, . . . , ISPn identified by the IP address is initialized for the corresponding data processing device DV1, . . . , DVn only.

Analogous to the second exemplary embodiment, an Internet connection, i.e., a communications connection to a device disposed in the IP-oriented network IPN, is initialized by an application B running on the first data processing device DV1, for example a Web browser. This is normally done when the application B is started or while the connection is being used. Information I is transferred by the application B to the selection unit CCRS. In the present exemplary embodiment, an IP address IP-A=123.123.123.1 is transferred by the application B to the selection unit CCRS.

With reference to the table Tab stored in the selection unit CCRS, in which the IP addresses IP-A are stored, on whose selection the default conversion device is reconfigured, the router device R identifies whether or not a communications connection to a new conversion device ISP1, . . . , ISPn is to be initialized. In the present exemplary embodiment, the IP address IP-A=123.123.123.1 is transferred to the selection unit CCRS as information I, whereby the selection unit CCRS re-allocates D-ISP=DS-ISP1 to the information identifying the default conversion device. A subsequent data transfer via the IP-oriented network IPN originating from a data processing device DV1, . . . , DVn connected to the local area network LAN is thus routed via the first conversion device ISP1. The first conversion device ISP1 is used as the default conversion device until a new IP address IP-A, likewise stored in the table TAB, is transferred by one of the data processing devices DV1, . . . , DVn to the router device R. The method can be implemented either on an individual-device or network-wide basis.

In the third exemplary embodiment, no direct allocation exists between an Internet address IP-A and a conversion device ISP1, . . . , ISPn, but merely an allocation of specific IP addresses IP-A for a transfer to a different conversion device ISP1, . . . , ISPn. The third exemplary embodiment represents a simpler implementation of the method according to the present invention compared with the second exemplary embodiment.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

Although the present invention has been described with reference to specific embodiments, those of skill in the art will recognize that changes may be made thereto without departing from the spirit and scope of the invention as set forth in the hereafter appended claims.

1. A method for setting up a connection via an IP-oriented network, the method comprising the steps of:
connecting a device, from which the connection originates, to a local computer network;
connecting the local computer network via a router device to a communications network;
connecting the communications network via a plurality of conversion devices to the IP-oriented network;
selecting one of the conversion devices, via a selection unit implemented in the router device, using information transferred by the device; and
setting up a communications link to the select conversion device via the communications network.

2. A method for setting up a connection via an IP-oriented network as claimed in claim 1, wherein the selected conversion device is a default conversion device, a communications link being set up via the default conversion device in cases where no information to the contrary is received in the selection unit.

3. A method for setting up a connection via an IP-oriented network as claimed in claim 1, the method further comprising the steps of:
initializing a connection setup by a first application running on the device; and
transferring the information originating from a second application running on any given device to the router device.

4. A method for setting up a connection via an IP-oriented network as claimed in claim 3, wherein the information is transferred via a separate connection via the local computer network.

5. A method for setting up a connection via an IP-oriented network as claimed in claim 1, the method further comprising the step of:
transmitting automatically, via the selection unit, a request message to the device which is transmitting the information in cases where no information is received in the selection unit.

6. A method for setting up a connection via an IP-oriented network as claimed in claim 2, wherein the default conversion device is configured by the selection unit as a function of time of day.

7. A method for setting up a connection via an IP-oriented network as claimed in claim 1, the method further comprising the step of:
automatically clearing down an existing communications connection between the device and a different conversion device at an end of a definable time period in cases where a new communications connection is set up between the device and a conversion device.

8. A method for setting up a connection via an IP-oriented network as claimed in claim 7, wherein the existing communications connection is not cleared down in cases where a different device connected to the local computer network continues to access this communications connection.

9. A method for setting up a connection via an IP-oriented network as claimed in claim 1, the method further comprising the steps of:
designing the selection unit according to a Domain Name Service proxy, wherein a Domain Name Service enquiry transferred from the device to the selection unit is checked to ascertain whether an Internet name corresponding to the Domain Name Service enquiry and identifying a conversion device is stored in the selection unit; and
forwarding the Domain Name Service enquiry, if the internet name is stored in the selection unit, via the communications network to the conversion device identified by the Internet name.

10. A method for setting up a connection via an IP-oriented network as claimed in claim 2, wherein the transferred information is an IP address and, when an IP address specifically set up in the selection unit and identifying a conversion device is transferred, the corresponding conversion device is re-configured as the default conversion device.

11. A method for setting up a connection via an IP-oriented network as claimed in claim 10, the method further comprising the step of:
routing IP addresses subsequently transferred from a device to the router device via the currently set up default conversion device until a new IP address specifically set up in the selection unit is transferred to the router device.

12. A router device for setting up a communications connection via an IP-oriented network, originating from a device connected to a local computer network, the local computer network being connected via the router device to a communications network which, in turn, is connected via a plurality of conversion devices to the IP-oriented network, the router device comprising:
a selection unit for selecting one of the conversion devices with reference to information transferred by any given device; and
a control unit for subsequent set-up of a communications connection via the communications network to the selected conversion device.

13. A router device as claimed in claim 12, wherein the selection unit is a server, a separate socket connection being provided between the device and the selection unit for transferring the information.

14. A router device as claimed in claim 12, wherein the selection unit is designed according a Domain Name Service proxy.

15. A router device as claimed in claim 12, wherein the selection unit is an IP address filter.
